(19) United States
(12) Patent Application Publication
(10) Pub. No.: US 2002/0184931 A1
(43) Pub. Date: Dec. 12, 2002

(54) Locking device

(76) Inventor: Reinhard Wittwer, Heiligenhaus (DE)

Correspondence Address: FRIEDRICH KUEFFNER, SUITE 910, 317 MADISON AVENUE, NEW YORK, NY, 10017, US

(21) Appl. No.: 10/160,440

(22) Filed: May 31, 2002

(30) Foreign Application Priority Data
Jun. 1, 2001 (DE) 101 26 909.9

(51) Int. Cl. B60R 25/00; E05B 65/12

(52) U.S. Cl. 70/237

(57) ABSTRACT

The invention pertains to a locking device, especially for the doors of motor vehicles, with a locking cylinder, which can be actuated by a key, with a lock mechanism for locking and unlocking the door, and with a transmission element between the locking cylinder and the lock mechanism, where rotating parts, on which the transmission element acts, are attached nonrotatably to the locking cylinder and to the lock mechanism.

According to the invention, the two rotating parts are designed as gear wheels and have sets of teeth extending at least part of the way around their circumferences, where the transmission element is designed as an elongated, rigid part, each of the two ends of the transmission element being provided with a set of opposing teeth, which engage in the teeth of the rotating parts.

The invention pertains to a locking device, especially for the doors of motor vehicles, with a locking cylinder to be actuated by a key, with a lock mechanism for locking and unlocking the door, and with a transmission element between the locking cylinder and the lock mechanism, where rotating parts, on which the transmission element acts, are connected nonrotatably to the locking cylinder and to the lock mechanism. Locking devices of this type are used especially to lock doors which are curved. In such cases the locking cylinder and the lock mechanism are a certain distance away from each other and must be connected to each other, but this cannot be done by a single, straight connection.

EP 1,004,729 A1 describes a solution in which the transmission element is designed as a double Bowden cable, where one of the two ends of the Bowden cable is attached to the rotating part of the locking cylinder and the other to the rotating part of the lock mechanism. These designs are relatively complicated, because separate guide pulleys must be provided to guide the Bowden cable properly. In addition, it is very difficult to adjust the length of the two Bowden cables, because they must be very accurately coordinated with each other so that the vehicle doors can be closed and opened properly. These types of arrangements are also relatively complicated to manufacture and relatively difficult to install.

The task of the invention is to design a locking system of the general type-indicated above in such a way that it can be produced at low cost, installed easily, and operated reliably, even when the axis of the locking cylinder is not aligned precisely with the axis of the lock but is instead offset with respect to either height or angle.

This task is accomplished according to the invention in that the two rotating parts are designed as gear wheels and have teeth over at least certain areas of their circumference; in that the transmission element is designed as an elongated, rigid part; and in that the two ends of the transmission element have opposing sets of teeth, which engage in the teeth on the rotating parts. The transmission element in this case is supported with freedom of rotation. This design make it possible, first, for the axes of the cylinder and of the lock, that is, the axes of the two rotating parts, to be at any solid angle to each other. Second, torque is transmitted uniformly over the entire range of rotational angles. Finally, the meshing with the opposing teeth allows the lock of the locking system to be opened and closed with precision. Because parts of this kind are fabricated out of plastic, they are both easy and inexpensive to produce and to install.

In a first exemplary embodiment of the invention, the rotating transmission element consists of two sector shaped segments, which are attached rigidly to each other; the opposing teeth are provided on the circumferential portion of each of these sectors, and the rotational axis is in the center between the two sector segments. The use of sector segments makes it easy to span a considerable distance between the axis of the locking cylinder and the axis of the lock. The sets of teeth and opposing teeth make it possible for the lock to be closed and opened with precision.

In another exemplary embodiment of the invention, the rotating transmission element is designed as a bar, each end of which is provided with a gear wheel, at least certain areas of which carry opposing teeth; the rotational axis extends in the longitudinal direction of the transmission element. This design also ensures that the axis of the locking cylinder can be controlled with precision with respect to the axis of the lock. In addition, a transmission element of this type occupies relatively little space, except in the area of the opposing teeth, because the bar-shaped part takes up little room. Nevertheless, the transmission element is supported and rotated securely, so that, when the locking cylinder is turned, the lock is moved easily into its locked position or unlocked position. The length of the locking part is freely selectable, which means that the distance between the locking cylinder and the lock can be adjusted with precision, which is advantageous when different types of automobiles are to be equipped with the device according to the invention.

It is advantageous for the two sector-shaped segments of the transmission element with the opposing sets of teeth to be designed as a single part, which allows low-cost production and reliable installation; in addition, an arrangement of this type also ensures reliable operation. Here, too, it is easy to adjust the transmission element length to suit each particular case.

It is recommended that a restoring spring be installed around the rotational axis of the transmission element, so that, after the transmission element has been turned, it can be returned to its starting position, regardless of the direction in which it was originally rotated. This arrangement makes it possible for the key to be returned almost automatically to its original position and then removed from the locking cylinder after the door has been opened or closed. In this design, the lock itself remains in its free or locked position, and the free position or the locked position is reversed or changed only when a new movement in the opposite direction is initiated.

In a special exemplary embodiment of the invention, the restoring spring is designed as a wing-type spring, one end of which works with a projection on the housing of the locking system, the other with a projection on the transmission element. During a first rotational movement, the first end is supported against the housing projection and the second against the transmission element. When another rotational movement occurs, the second end engages with the housing projection and the first end with the transmission element.

In a special exemplary embodiment of the invention, the teeth of the rotating part and the engaging set of opposing teeth on the transmission element are designed as a bevel drive so that, if the axis of the locking cylinder is offset from the axis of the lock, they can nevertheless be aligned precisely to ensure that the forces are transmitted reliably.

It is favorable for the axis of the lock, seen from the side, to intersect the axis of the transmission element, whereas the axis of the locking cylinder is parallel to the axis of the transmission element. As a result, it is easy to compensate for any offset with respect to height or the angle between the axes, thus ensuring accurate transmission of the torque and accurate installation.

It is recommended that the axis of the locking cylinder, seen from the side, intersect the rotational axis of the transmission element. In this way, a compact arrangement of the locking device is obtained, because locating the intersection properly allows the locking device to be installed in a very small amount of space.

It is recommended that the intersection of the axis of the locking cylinder with the axis of the transmission element be located on the side of the locking cylinder. The reason for this is that, because the transmission element does not project but proceeds only up as far as the locking cylinder, the area of the locking cylinder can be made quite small. It is advantageous for the sets of teeth or opposing teeth extending over certain areas around the axis of the locking cylinder and/or around the axis of the transmission element and/or around the axis of the lock to extend only over an angle of about 120°0 in both rotational directions from a home position, advantageously of only 90°, because this measure greatly simplifies the work required to fabricate the lock system. The reason for this is that the injection molds used for the gear wheels do not have to produce a complete gear wheel but rather only a part of such a wheel. In spite of this, the turning of the key in the locking cylinder still results in the reliable rotation of the lock around its axis.

In another exemplary embodiment of the invention, a step is provided to give one of the sector-shaped segments of the transmission element a parallel offset from the other sector segment. Here, too, the goal is achieved that the space required for a locking system of this type is readily available in a door. In addition, the opposing set of teeth rotate radially around the rotational axis of the transmission element. To be able to compensate for the tolerances which arise during installation, it is recommended that the connecting means between the rotating part of the lock mechanism and the lock mechanism itself be supported in the rotating part in the manner of a universal joint, so that, upon rotation of the rotating part, the connection can perform compensating movements when the lock is turned.

To simplify the installation of the locking system according to the invention even more, it is recommended that the locking cylinder be designed so that it can be inserted like a plug into a receptacle in the housing and fastened in place there, so that, as the final step of installation, the locking cylinder can simply be inserted.

Several exemplary embodiments of the object of the invention are illustrated in the drawings:

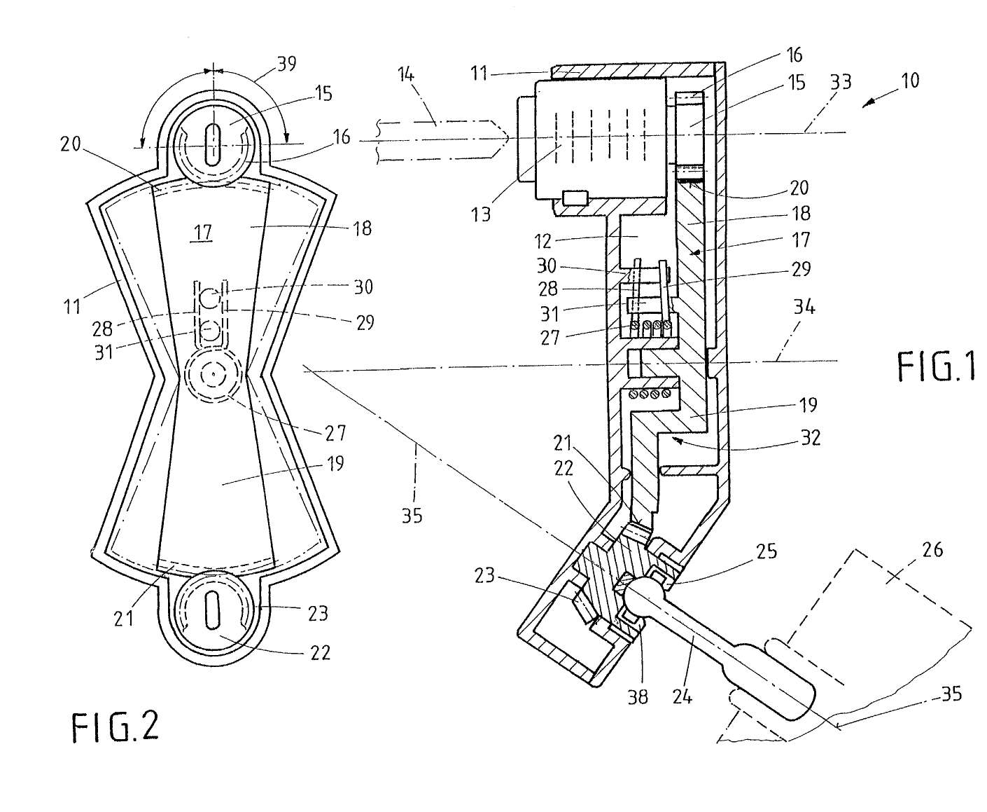

FIG. 1 shows a cross section of a first exemplary embodiment of the locking device;

FIG. 2 shows a front view of the transmission element with the rotating parts and a partially open cover;

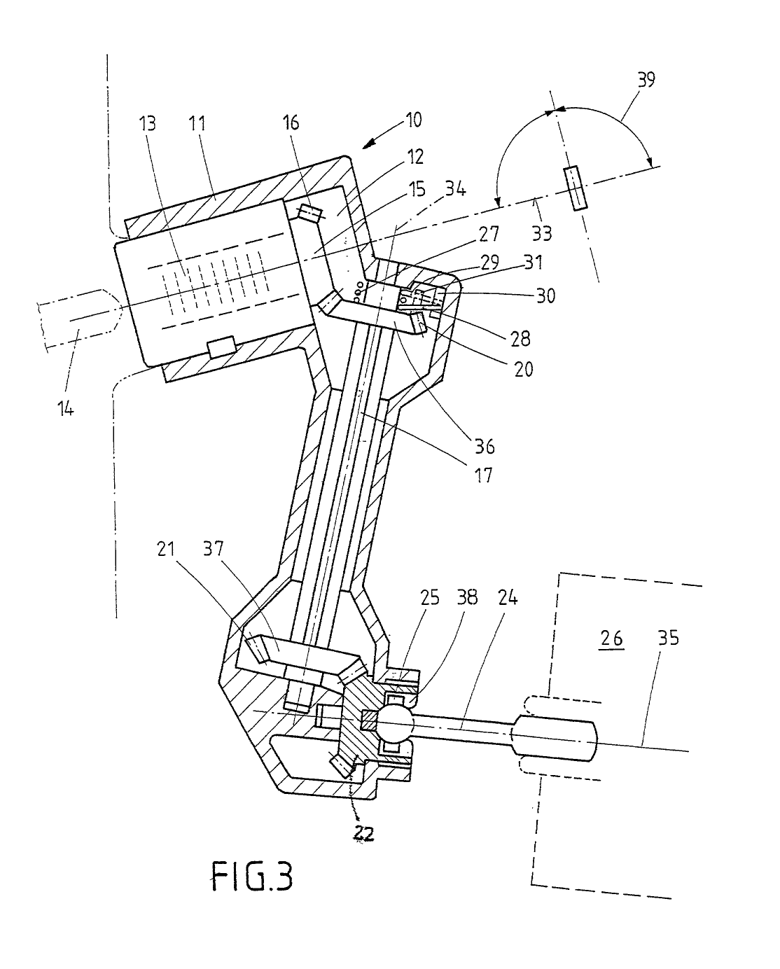

FIG. 3 shows another exemplary embodiment with bevel gears as part of the locking device; and

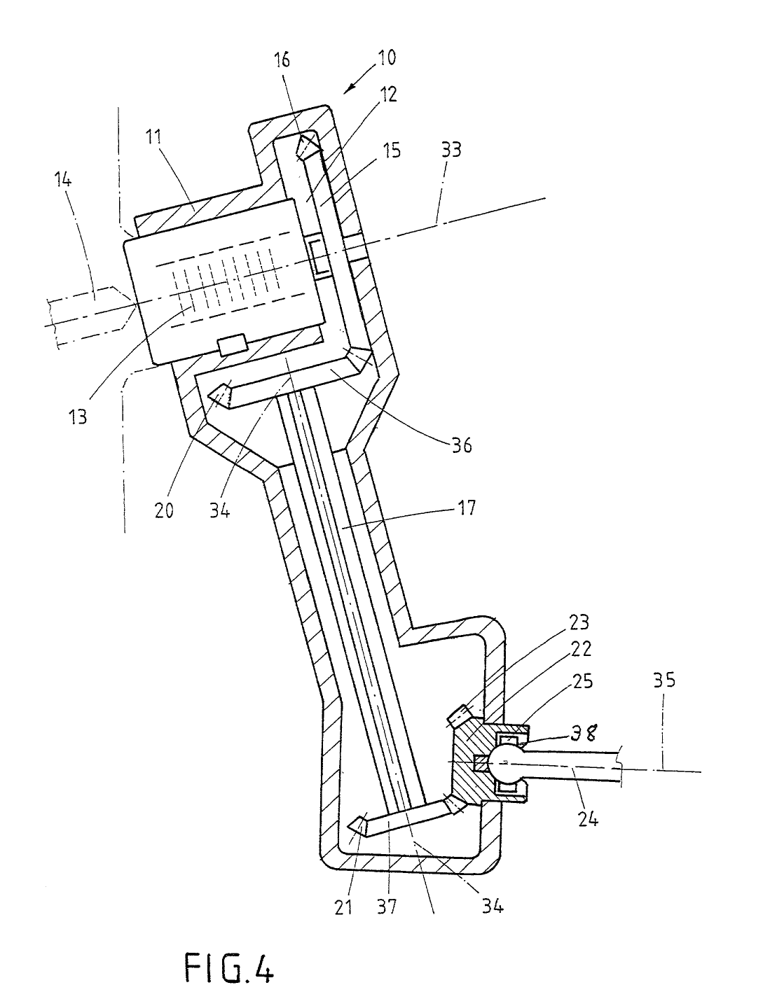

FIG. 4 shows another exemplary embodiment of bevel gearing.

It should be remarked in advance that the locking device is illustrated only in schematic fashion. The locking cylinder and the lock can be designed in various ways known in and of themselves.

The locking device 10 shown in FIG. 1 consists of a two-part housing 11, in the receiving space 12 of which a locking cylinder 13 and a transmission element 17 are provided. A gear wheel 15 is attached nonrotatably to the cylinder of the locking cylinder. This gear wheel has a set of teeth 16 which meshes with a set of opposing teeth 20 on the transmission element. The transmission element 17 consists of two sector segments 18, 19; the rotational axis 34 of the transmission element is between the two sector segments.

As can also be seen in FIG. 1, a step 32 is provided in the sector segment 19. As a result of this measure, the set of opposing teeth 21 of the lower sector segment 19 is offset. This set of opposing teeth is beveled. It engages with the second rotating part of the locking device, which is also designed as a bevel gear 22 with beveled teeth 23. As a result of this angular offset, the rotational axis of the second gear wheel 22 intersects the rotational axis 34 of the transmission element. The axis of the locking cylinder and the axis of the lock mechanism can thus be connected together to rotate in unison, because the bevel gears and the step make it possible to provide any required offset in height or angle between the axes. It should be mentioned here that the design of the set of opposing teeth 20 is different from that of the set of opposing teeth 21.

To transmit the rotational movement of the gear wheel 22 to the lock, a connecting paddle 24 is provided. This connecting paddle is connected nonrotatably to the gear wheel 22. It can wobble slightly in its holder 25, however, in order to compensate for tolerances between the axis of the rotating parts and the lock. The holder 25 for the connecting paddle is designed in practice as a universal joint so that different types of tolerances can be compensated. A restoring spring 27, which is designed as a wing-type spring, is placed around the rotational axis 34 of the transmission element 17. In the starting position (see FIG. 2), the end of one of the spring arms 28, 29 rests against a stop 30 on the housing, while the end of the other spring arm rests against a stop 31 on the transmission element 17.

Starting from the position shown in FIG. 2, the spring arm 29 tensions the restoring spring 27 when the transmission element rotates in the clockwise direction, while the spring arm 28 rests behind the stop 30 of the housing.

Upon movement in the counterclockwise direction, the spring arm 28 rests against the stop 31 of the transmission element. The spring is tensioned, while the stop 30 holds the spring arm 29 in position. Upon release of the rotating movement, the transmission element, driven by the spring, returns to the position shown in FIG. 2.

It should also be mentioned here that the turning of the key 14 moves the cylinder 13 to one side or the other, depending on the direction in which the key is turned. As can be seen in FIG. 2, the maximum rotational angle proceeding from the starting position in this exemplary embodiment is no more than 90°0 to either side.

It should also be mentioned that the sector-like segments 18, 19 have sector angles of approximately 30°. The size of the sector angle, however, depends on how long the transmission element is overall and on how much circumferential distance must be made available for the opposing teeth on the transmission element.

In the exemplary embodiment according to FIG. 3, the transmission element 17 is designed as a bar. Gear wheels 36, 37, designed as bevel gears, are provided at each end. The two bevel gears 36, 37 carry the opposing sets of teeth 20, 21. The gear wheel 15, which is also designed as a bevel gear, and the gear wheel 22, which also carries a set of beveled teeth, mesh with the bevel gears 36, 37. The restoring spring 27 is provided at one end of the transmission element 17. The two ends 28, 29 of the spring work together with the corresponding stops 30, 31, so that, in this case, too, the return to the starting position will always be ensured. The rotating cylinder 13 allows a rotational angle of 90°0 in both directions. The sets of teeth and opposing teeth must therefore be designed accordingly.

It should be mentioned here that the diagram is purely schematic. The exact openings in the housing and the exact means of attaching the individual gear wheels are not shown in explicit detail.

It should also be said that the rotational axis 34 of the transmission element intersects the rotational axis 35 of the lock mechanism, and also that the rotational axis 33 of the cylinder intersects the rotational axis 34 of the transmission element. Depending on the curve of the door, that is, on the place where the locking device must be installed, it is possible, through suitable choice of gearing, to limit the locking device to a size which will fit within the space available to receive it.

In the exemplary embodiment according to FIG. 4, which is similar in design to the exemplary embodiment of FIG. 3, the intersection of the cylinder axis and the transmission element axis is inside the locking cylinder. It should also be pointed out that the attack point of the sets of teeth and opposing teeth in question is selected in such a way that, upon rotation of the locking cylinder toward the right, that is, rotation in the clockwise direction, the connecting paddle 24 also rotates toward the right. As a result, through appropriate choice of the intersections of the individual rotational axes with each other, a unit is again obtained which is narrow but of considerable length, which nevertheless is able transmits torque uniformly over the entire range of angles, thus making it easy for the user to operate the lock.

In regard to FIG. 4, it should also be pointed out that the connecting paddle 24 is held in place in the holder 25 by catches 38. The connecting paddle is readily able to perform slight pivoting movements in the holder toward all sides. Inserting the paddle into the holder requires merely a snapping-in operation.

As already mentioned, the embodiments described above represent only examples of ways in which the invention can be realized. The possibilities are not limited to them. Instead, there are many other possible modifications and applications which can be imagined. Instead of the double-sector design of the transmission element, the areas carrying the opposing sets of teeth could also be designed as independent segments, in which case the two opposing or nearly opposing segments would be connected to each other by a rod or bar. The center of rotation of the transmission element would again be exactly in the middle between the two segments.

### List of Reference Numbers

10 locking device

11 housing

12 receiving area in the housing

13 locking cylinder

14 key

15 gear wheel

16 set of teeth

17 transmission element

18 sector segment

19 sector segment

20 opposing set of teeth

21 opposing set of teeth

22 gear wheel

23 set of teeth

24 connecting paddle

25 holder for 24

26 locking mechanism

27 restoring spring

28 spring arm

29 spring arm

30 stop on the housing

31 stop on 17

32 step in 19

33 rotational axis of the locking cylinder

34 rotational axis of the transmission element

35 axis of the lock

36 bevel gear

37 bevel gear

38 catches

1. Locking device, especially for the doors of motor vehicles, with a locking cylinder which can be actuated by a key, with a lock mechanism for locking and unlocking the door, and with a transmission element between the locking cylinder and the lock mechanism, where rotating parts, on which the transmission element acts, are attached nonrotatably both to the locking cylinder and to the lock mechanism, characterized in that the two rotating parts (15, 22) are designed as gear wheels, each having a set of teeth (15, 23) extending at least part of the away around their circumference; in that the transmission element (17) is designed as an elongated, rigid part; and in that each end of the transmission element (17) is provided with a set of opposing teeth (20, 21), which engage in the sets of teeth (16, 23), the transmission element (17) being supported with freedom of rotation.

2. Locking device according to claim 1, characterized in that the rotating transmission element (17) consists of two sector-shaped segments (18, 19), which are attached rigidly to each other and which carry the opposing sets of teeth (20, 21) on the circumferential area of their sectors, where the rotational axis (34) of the transmission element (17) is located in the center between the two sector segments (18, 19).

3. Locking device according to claim 1, characterized in that the rotating transmission element (17) is designed as a bar with gear wheels (36, 37) mounted at its ends, which gear wheels carry opposing sets of teeth (20, 21) extending at least part of the way around the circumference, where the rotational axis (34) of the gear wheels extends in the longitudinal direction of the transmission element (17).

4. Locking device according to claim 1 or claim 2, characterized in that the two sector-shaped segments (18, 19) with the opposing sets of teeth (20, 21) of the transmission element (17) are designed to form a single piece.

5. Locking device according to one of claims 1-4, characterized in that a restoring spring (27) is placed around the rotational axis (34) of the transmission element (17), so that, after the transmission element (17) has been rotated, the spring can return the transmission element (17) to its starting position regardless of the direction in which it was turned.

6. Locking device according to claim 5, characterized in that the restoring spring (27) is designed as a wing-type spring, one of the two ends (28, 29) of which is assigned to a projection (30) on the housing of the locking device, the other to a projection (31) on the transmission element (17), where, upon a rotational movement, one end (28) is supported on the housing projection (30) and the other (29) on the stop (31) of the transmission element.

7. Locking device according to one of claims 1-6, characterized in that the set of teeth (23) on the rotating part (22) of the lock mechanism (26) and the engaging set of opposing teeth (21) on the transmission element (17) are designed as bevel gear teeth.

8. Locking device according to one of claims 1-7, characterized in that, seen from the side, the axis (35) of the lock mechanism (26) intersects the axis (34) of the transmission element (17), whereas the axis (33) of the locking cylinder (13) is parallel to the axis (34) of the transmission element (17).

9. Locking device according to one of claims 1-8, characterized in that the intersection of the locking cylinder axis (33) and the axis (34) of the transmission element (17) is on the side of the locking cylinder.

10. Locking device according to one of claims 1-9, characterized in that the set of teeth (16, 23) and/or the set of opposing teeth (20, 21) extending around certain areas of the locking cylinder axis (33) and/or around the axis (34) of the transmission element (17) and/or around the axis (35) of the lock mechanism (27) extend only over a an angular range of 120°0 in both directions, advantageously of 90°, from a starting position.

11. Locking device according to claim 1 or claim 2, characterized in that a step (32) is provided to give the sector segment (18) a parallel offset to the other sector segment (18).

12. Locking device according to one of claims 1-12, characterized in that the connecting means (24) between the rotating part (22) of the lock mechanism (26) and the lock mechanism (26) itself is supported in the rotating part (22) in the manner of a universal joint.

13. Locking device according to one of claims 1-12, characterized in that the locking cylinder (13) can be inserted like a plug into a receptacle in the housing and held in place there.
